(19) United States
(12) Patent Application Publication
(10) Pub. No.: US 2007/0160334 A1
(43) Pub. Date: Jul. 12, 2007

(54) End-emitting fiber optic indicia for motor vehicles

(76) Inventors: Weston Tyler Cobb, Kingsport, TN (US); Stephen Andrew Jackson, Kingsport, TN (US)

Correspondence Address: Weston T. Cobb, 5304 Lonesome Pine Rd., Kingsport, TN, 37664, US

(21) Appl. No.: 11/328,935

(22) Filed: Jan. 10, 2006

(51) Int. Cl. G02B 6/06; B60Q 1/26

(52) U.S. Cl. 385/116; 362/487

(57) ABSTRACT

An illuminable indicia for mounting onto a motorized vehicle comprising a fiber optic light bundle having a plurality of end emitting fiber optic strands terminating into terminal ends forming a pre-selected and fixed pattern corresponding to the shape of the indicia. The end emitting fiber optic strands are capable of forming complicated and intricate designs having a high pixel density and brightly illuminated. The pattern can be in the shape of a logo, letter, picture, and may be multicolored or flash colors in a programmed sequence.

### 1. FIELD OF THE INVENTION

The present invention relates to a fiber optic bundle terminating into a preselected fixed pattern suitable for mounting onto a motorized vehicle. When energized by a light source, the fiber optic bundle arrangement directly forms the desired pattern.

### 2. BACKGROUND OF THE INVENTION

There exists a variety of illuminating displays and emblems for automotive vehicles. These illuminated displays operate by providing a template which allows background light to transmit through only a portion of the template. The template, or face plate, is cut into a selected shape, such as a letter, logo, or emblem, as either a positive or negative template, such that the randomly scattered background transmitted through the openings on the template form a desired illuminated logo or emblem. The background light is merely the source of illumination such as an incandescent lamp, fluorescent lamp, or a fiber optic source, but it is the template between the viewer and the light source which is the source of the illuminated pattern. In these known assemblies, it is the template or face plates which bear the desired indicia.

For example, U.S. Pat. No. 6,190,026 describes an illuminated automotive emblem for mounting on a vehicle having housing frame component with a central opening that creates a picture frame or bordering effect through a template illuminated from behind through translucent portions of the display template. The illuminant can be an electroluminescent lamp, incandescent bulb, a gas filled tube, or a fiber optic.

Translucent cords containing fiber optic strands arranged within the cord to illuminate the cord have also been designed. The desired pattern is formed by bending and arranging the cord itself into the desired pattern followed by affixing the cord to the substrate in the pattern desired. Such cords can be, for example, lined along the perimeter of swimming pools or snaked through the along the engine of a motorcycle or its chassis, or wound into a desired pattern along the bottom rocker panels of automobiles or along other parts of an automobile body in a shape selected by the end user, and thereafter fastened to the pool, chassis, or body in the pattern arranged by the end user.

Such cords are too thick to form intricate patterns such as small logos. Further, the fiber optic strands within the cord emit light to illuminate the cord and it is the illuminated cord, not the light emission itself, which is arranged to form the desired pattern. These types of cords often contain side emitting fiber optics in which the light is emitted along the entire strand of the fiber optic. One example of a side emitting fiber optic cord used in vehicles is as described in U.S. Pat. No. 6,854,869.

It would be desirable to have the ability to form intricate patterns. We have discovered that it would be desirable to form indicias such as letters, logos, and emblems using end emitting fiber optics as the direct source of the pattern. In this way, intricate pre-selected indicias can be formed which are brightly illuminated with high resolution, thereby providing the ability to form intricate patterns.

### 3. SUMMARY OF THE INVENTION

There is now provided an illuminable indicia for mounting onto a motorized vehicle comprising a fiber optic pattern assembly, said assembly comprising a fiber optic light bundle comprising a plurality of end emitting fiber optic strands terminating into terminal ends forming a pre-selected and fixed pattern corresponding to the shape of the indicia. The fiber optic light bundle desirably has a first end attached to a connector and a second end branching into a plurality of fiber optic strands, which optionally may split into multiple strands. The fiber optic assembly is directly or indirectly connected to a transmitting light source which transforms electrical energy into light energy. The light source optionally generates or is split into or comprises different colors of the visible light spectrum. The indicia is suitably mounted onto the body of a motorized vehicle, the instrument panel of a motorized vehicle, the seat of a motorized vehicle, a headliner or interior door panel, or onto a motorcycle chassis or engine frame.

### 4. BRIEF DESCRIPTION OF THE DRAWINGS

FIG. 1 illustrates a fiber optic bundle assembly 100.

FIG. 2 is a front view of a fiber optic assembly comprising a plurality of fiber optic strands terminating into terminal ends 201 forming a pre-selected fixed pattern of a

FIG. 3 is a perspective view of a fiber optic assembly forming a pattern corresponding to a desired indicia.

FIG. 4 illustrates several indicia having a decorative shape distinct from the surface onto or within which it is mounted.

FIG. 5 illustrates an embodiment in which the terminal ends of the fibers end in multiple parallel planes within the indicia.

FIG. 6 is top view of a fiber optic assembly mounted through a vehicle trunk area.

### 5. DETAILED DESCRIPTION OF THE INVENTION

The invention will now be described with reference to the attached drawings which illustrate one or more embodiments of the invention, although it is understood that the scope of the invention is defined by the claims and not limited to embodiments as shown in the drawings.

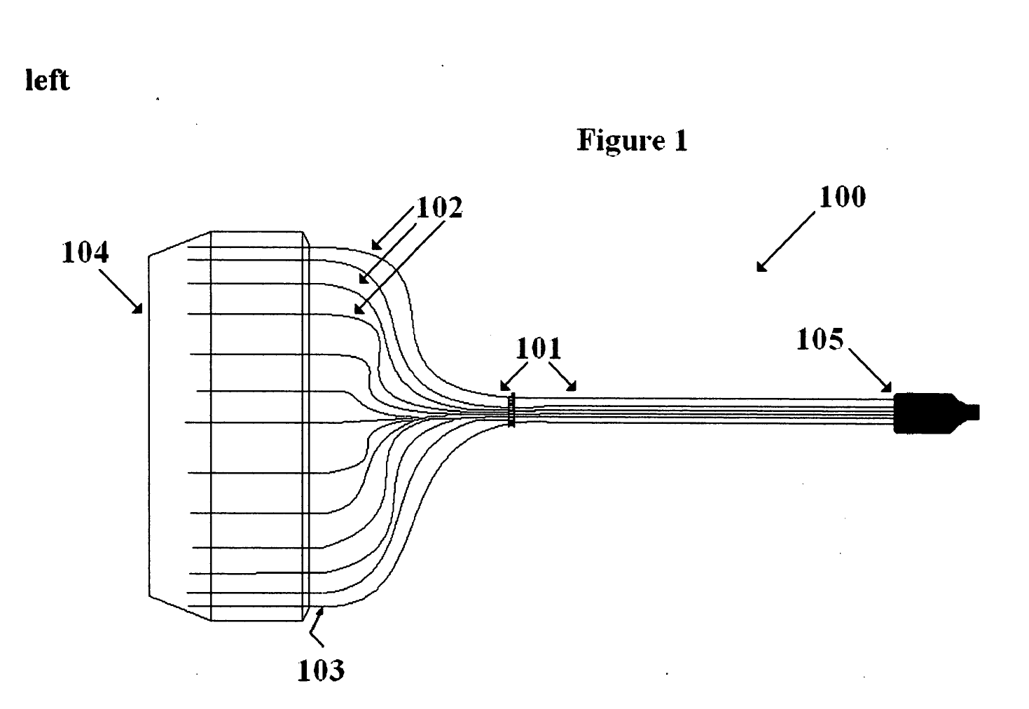

FIG. 1 illustrates a fiber optic bundle assembly 100. The assembly is made of a fiber optic bundle 101 arranged into a plurality of fiber optic strands. The fiber optic light bundle comprising a plurality of fiber optic strands 102 terminates into terminal ends 103 forming a pre-selected fixed pattern 104. The fiber optic bundle is optionally attached to a connector 105 for connecting directly to a transmitting light source (not shown) or to another connector attached to a transmitting light source or other source for converting electric energy into light energy. The fiber optic bundle 101 divides into smaller discrete bundles containing fewer strands than found in the main trunk bundle, and these smaller discrete bundles may optionally further divide into bundles with fewer strands within each bundle or into single fiber optic strands forming the terminal ends 103, with the total terminal ends equaling the number of strands within the main trunk bundle. The terminal ends may comprise a pattern of single discrete fiber optic strands, or may comprise a pattern of small fiber optic bundles having two or more fiber optic strands per bundle, with discrete bundles arranged into a pattern, or a combination of both. Thus, the fiber optic bundles may continue dividing into smaller bundles until terminating at a terminal end, with each terminal end forming a small fiber bundle (having fewer fiber optic strands than in the main trunk) or forming single discrete fiber optic strands. Further, if desired, the fiber optic strands may branch or split in addition to dividing the bundle. As shown in FIG. 1, the individual fiber optic strands 102 may branch into additional fiber optic strands at a branch point 105 such that the total number of terminal ends exceeds the number of fiber optic strands in the main trunk.

The fiber optic strand is of typical configuration, including a core for transmitting light, a cladding for reflecting into and trapping the light in the core and guides it along the core even through bends, and a buffer or coating such as plastic on the outside of the fiber cladding that protects the fiber strand from moisture or other physical damage. The fiber optic strand may be single mode or multi-mode. A multi-mode can propagate hundreds of modes. With the use of LEDs as the light source, with short distances experienced in vehicles, and desirably having a larger core with the use of LED's, the fiber optic strand is desirably multi-mode.

The light traveling through the fiber optic strands is emitted from or out the terminal ends of the fiber optic strands, commonly known as an end-emitting fiber optic strands in contrast to side emitting fiber optic strands. The end emitting fiber optic strands contain a glass or other light transmitting core surrounded by a cladding which internally reflects light back into the core rather than allowing light to transmit out from the side of the core as in the case of a side emitting fiber optic strand. The end-emitting fiber optic strand preferably is not made with a reflective surface on the terminal end since reflective surfaces do not allow the light to emit from the terminal fiber optic strand. Preferably, the terminal end of the fiber optic strand is not shrouded or encased in a ferrule or any other mechanical device to fix the fiber in place. Depending upon the location of the indicia on the motor vehicle and type of indicia design, the bending radius of the fiber optic strand should be considered. The needed bending radius will determine the fiber optic strand diameter and the material of construction.

The optical fiber core can be of any desired material. Suitable optical fiber materials for transmitting light include glass, quartz, silica, plastic such as polymethylmethacyrlate, sapphire, germanium oxide, zirconium fluoride, chalcogenide, silver halide, or any other suitable material which transmits light. Preferably, the material of construction chosen for the core transmits light in the visible spectrum since the indicia should be viewable by the observer. Preferably, the core comprises a plastic, a silica/silica fiber, a quartz polymer clad silica, or a glass optical fiber. In another embodiment, the fiber optic core can be liquid which have the advantage of less light loss and higher intensity as end-emitters and are generally more flexible to navigate tight bends into the indicia if needed. Such liquid fiber optics are generally constructed of a flexible plastic tube filled with a non-toxic liquid, which tube is covered by flexible metallic tubing surrounded by a thin plastic jacket.

The diameter of the fiber optic is not limited, but should be small so as to provide a larger number of fiber optic strands which is desirable for making intricate designs with high contrast and high number of terminal ends or “pixels”. Fiber optic diameters can range from 0.01 μm (microns or micrometers) up to about 2 millimeters. Standard plastic fiber optic strand diameters are at about 0.75 mm, 1.0 mm and 1.5 mm. The cable assembly can be of any industrial grade, including light, standard, and process. The covering or buffer may be a thermoplastic, polytetrafluoroethylene, or steel or any other suitable material to encase the cladding and core. In cores which use glass or a material other than plastic, the core diameter may be quite small, ranging from about 50 μm to 1000 μm, typically 50 μm to 100 μm, in multi-mode applications; and in single mode use, the core is desirably smaller, around 0.5 μm to less than 50 μm, typically from 0.5 μm to 15 μm. The outer diameters of the fibers which includes the core, cladding, and outer layer or sheathing, in both multi and single mode uses for cores other than plastic are typically in the range of 80 to 150 μm. Multi-mode fibers may be step index or a graded index to compensate for modal dispersion.

Multi-mode fiber is particularly desired when using an LED transmission light source or an illuminator. It is desirable to use a multi-mode fiber having a refractive index that is graded or stepped. With use of multi-mode, connector alignment is also less critical than with the use of single mode fibers.

The fiber optic strands are bundles into one or more cables in a trunk, and the cables are preferably protected with a jacket to protect against heat and other physical damage.

The terminal ends of the fiber optic strands form a pre-selected fixed pattern. A pre-selected fixed pattern is one in which the fiber optic strands are sufficiently fixed in place such that the strands do not move about in a random fashion and require the application of a mechanical, chemical, or thermal force to alter their location. One first pre-selects the desired arrangement or pattern of the fiber optics strands, followed by fixing the terminal ends of the fiber optic strands in place based on the selection. At least a portion of the fiber optic strands do not move to the touch and are fixed in a manner which prevents the terminal ends from moving, and more preferably, the terminal ends of the fiber optic strands are embedded within a matrix which renders the terminal ends inaccessible to human touch. In another embodiment, the terminal ends of the fiber optic strands are fixed in place sufficiently that a destructive force to either the fiber optic or the fastening means holding the terminal ends in place would have to be applied. An example of a destructive force would the application of heat to melt the polymer matrix around the terminal ends.

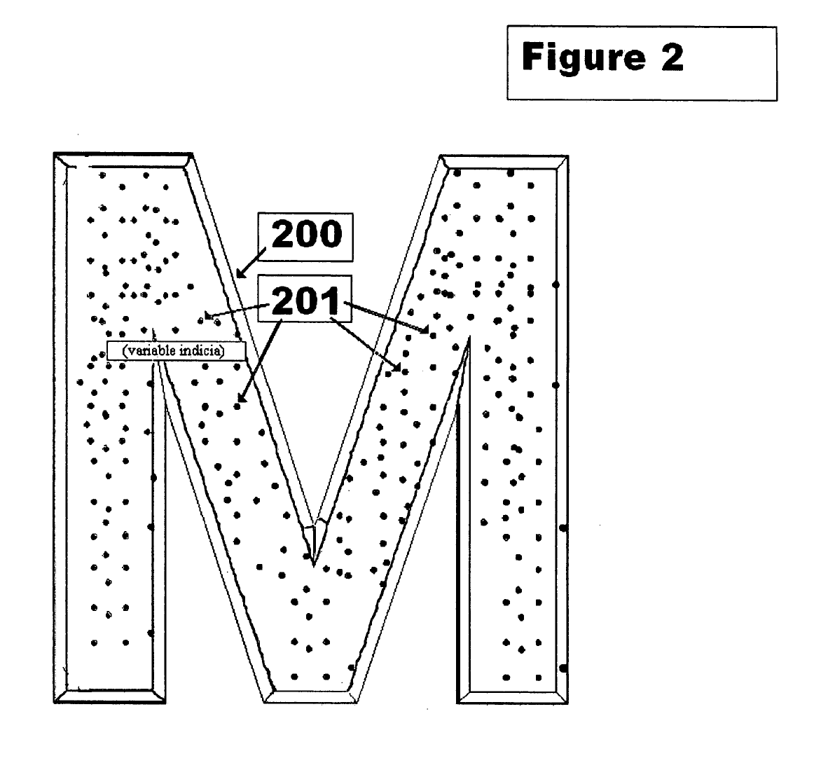

The pre-selected fixed pattern corresponds to the desired indicia as shown in FIG. 2. In this embodiment, there is provided a front view of a fiber optic assembly comprising a plurality of fiber optic strands terminating into terminal ends 201 forming a pre-selected fixed pattern of a “M” 200. The “M” pattern 200 is pre-selected as the desired indicia, and having selected the “M”, the fiber optic strands are arranged into a “M” pattern and then fixed in place as a “M” pattern such that the terminal ends forming the pattern are not moveable and stay in place to form the “M” pattern.

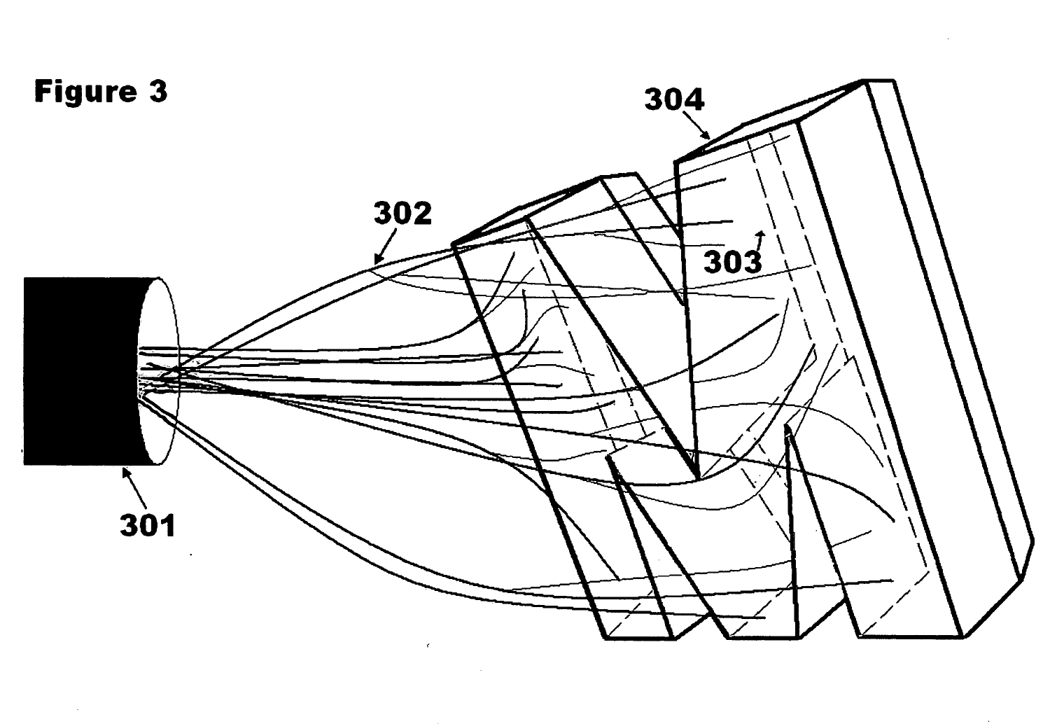

FIG. 3 illustrates a perspective view of a fiber optic assembly forming a pattern corresponding to a desired indicia. Fiber optic bundle 301 divides and into smaller fiber optic bundles 302 with reduced numbers of fiber optic strands and ultimately terminating into terminal ends 303. The fiber optic strands terminate as individual discrete strands or in small bundles. The terminal ends are fixed in place by any suitable means, such as being embedded in a plastic resin 304. As shown in FIG. 3, the plastic resin into which the terminal ends are embedded is also in the shape of an indicia, in this case a letter “M.” The terminal ends of the fiber optic strand fixed in place are arranged in a pattern, in this case the shape of an “M.”

In one embodiment, a portion of the fiber optic strand within 6 (six) inches, or within 4 inches, or within 2 inches, or within 1 inch from the terminal end of the fiber optic strands is embedded in a polymer resin. Most preferably, the terminal ends of the fiber optic strand are embedded in a polymer resin. In another embodiment, a portion of the fiber optic strands are embedded in a polymer resin, and another portion of the fiber optic strands are not.

The terminal ends of the fiber optic strands may be secured into the indicia by an adhesive or may be molded into place. Embedding or molding the fiber optic strands into a polymer resin is one means by which the fiber optic terminal ends can be fixed in place. Suitable polymer resins into which a portion of the fiber optic strands are embedded include thermoplastic and thermosetting resins. Preferably, the polymer resin above the terminal ends allows the transmission of light from the terminal ends. Such resins are either translucent or clear to the eye, and most preferred are resins which provide low light scattering effects. If desired, the polymer resin may be tinted with a color so that light is reflected at one pre-selected wavelength band. Optionally, at least 60% of light within the visible light spectrum is transmitted through the polymer resin.

The light emitting surface on the terminal end of the fiber optic strand may be embedded in a polymer resin or may be exposed. If exposed, it is preferred to expose less than ¼ inch of the fiber optic from its terminal end to the surface of the resin, more preferably less than ⅛ of an inch, or less than 1/32 inch.

The fiber optic strands can be arranged into any desired pattern corresponding to the desired indicia. The indicia is capable of being discerned by the naked eye within 7 feet as the intended pattern. In one embodiment, the fiber optic strands are arranged into an automobile logo indicia. In another embodiment, the fiber optic strands are arranged into lettering corresponding to an automobile name or abbreviation indicia. In another embodiment, the fiber optic strands are arranged into a word indicia. In yet another embodiment, the fiber optic strands are arranged into an emblem. In another embodiment, the fiber optic strands are arranged into pin striping indicia, or an indicia which circumscribes a license plate, bumper, or other automotive body part.

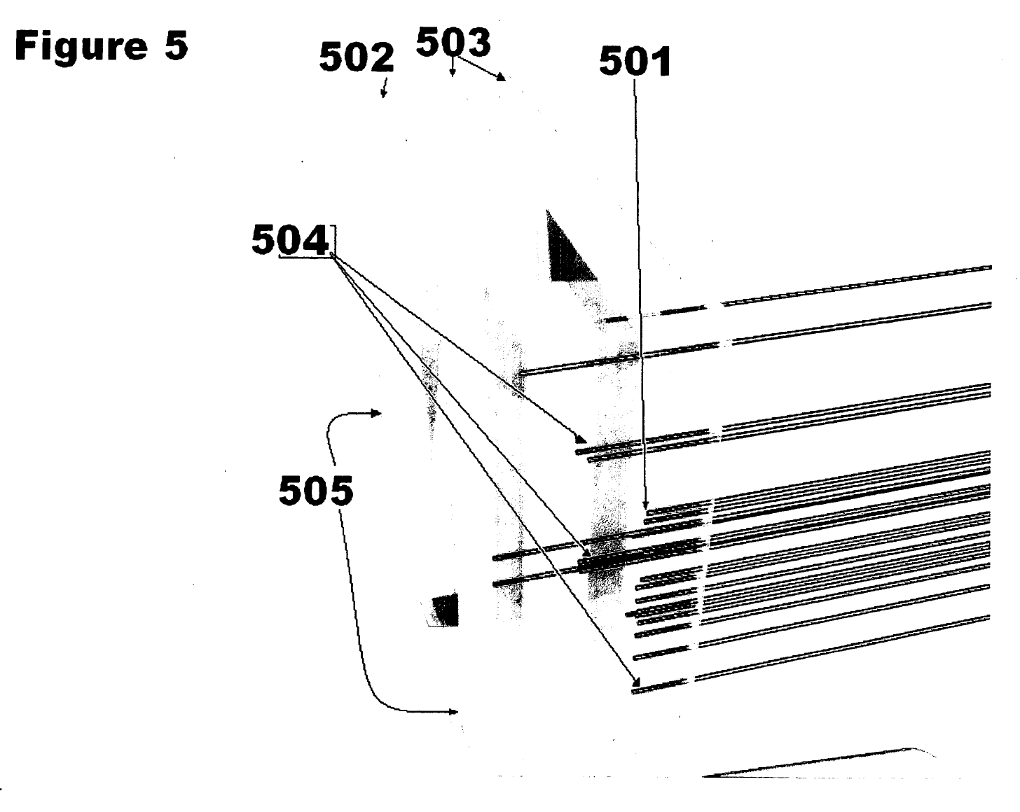

If desired, the terminal ends of all fiber optic strands may terminate in one imaginary plane, or in multiple parallel planes, preferably all within a polymer matrix. The plane may be curved, or may be flat. FIG. 5 illustrates an embodiment in which the terminal ends 501 end in multiple parallel planes 502 and 503 embedded within a polymer matrix 504 forming the indicia 505.

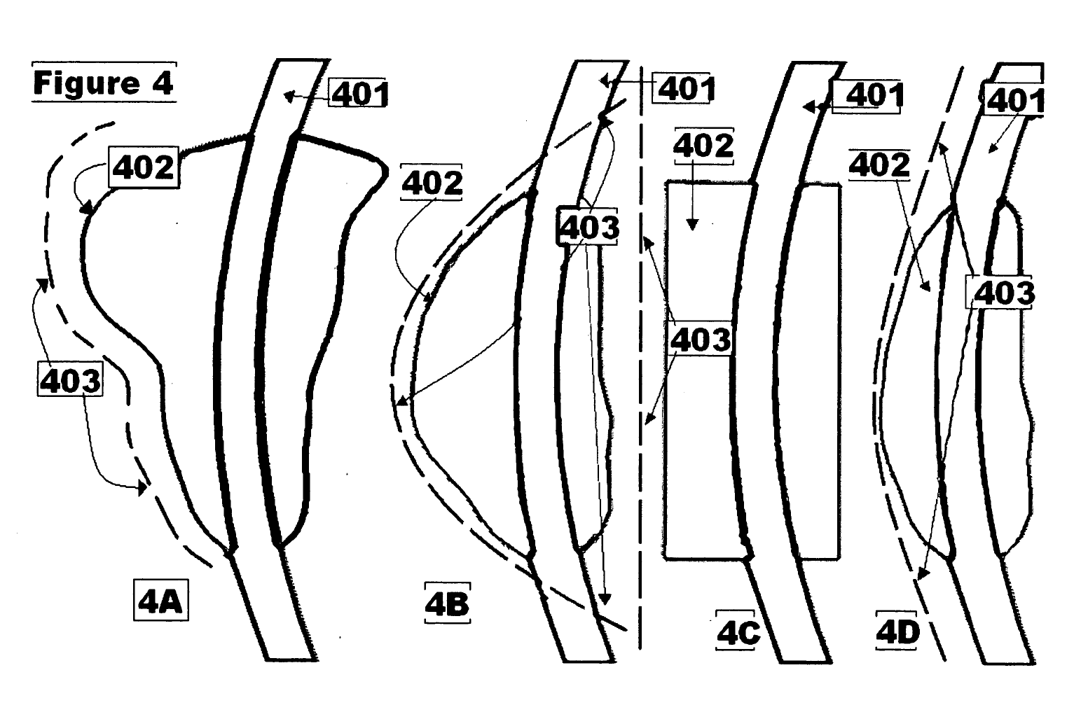

In another embodiment, the indicia comprised terminal ends of fiber optics embedded in a polymer matrix, said indicia having a decorative shape distinct from the surface onto or within which it is mounted. Thus, there is mounting surface, such as a vehicle exterior body, onto or within which the indicia is mounted or molded, said indicia protruding from the surface to form a shape does not have any contours substantially the same as, or the same as, the contour of the mounting surface. FIG. 4 illustrates several example of this embodiment. FIG. 4A is a side view illustrating a mounting surface 401, such as a rear deck lid, onto which an indicia 402 is mounted. The indicia 402 does not have any contours 403 following the contour of the mounting surface. While the indicia depicted in FIG. 4B is curved, its circumference is smaller than that of the mounting surface curve, having a contour 403 which does not follow the contour of the mounting surface. The indicia 402 in FIG. 4C forms right angles and flat planar surfaces. The indicia illustrated in FIG. 4D has a contour 403 which substantially follows the contour of the mounting surface

In another embodiment, a plurality of fiber optic strands form multiple visibly distinct patterns in which at least one pattern is capable of illuminating without illuminating one or more other patterns. In this embodiment, multiple patterns can be embedded within a polymer matrix, and one has the option of randomly, in a programmed sequence, or at the operator's selection, illuminate the desired pattern. The multiple patterns may be of the same color or different colors, and may be illuminated one at a time, or in combination at the same time.

In each of these embodiments, the indicia containing fiber optic strands is applied to motorized vehicles. Suitable motorized vehicles include motorcycles, all terrain vehicles, and passenger automobiles and motorcycles. Alternatively, the motorized vehicle may be a racing vehicle.

There is no particular limitation on how the indicia is mounted onto the vehicle, and those of skill are aware of mounting techniques. The indicia may be bonded or adhered; or screwed, clipped, crimped, friction fitted, notched, riveted, or otherwise mechanically fastened to the body exterior. If required, the fiber bundle penetrates the outer surface of the vehicle body through preformed or drilled holes to the interior of the vehicle body, thereby accommodating the wiring to run along the interior surfaces of the vehicle hidden from view from the outside of the vehicle.

In one embodiment, the indicia is mounted on or in a vehicle outer surface, or a metal or plastic surface, viewable to the observer standing outside the vehicle when illuminated standing at a distance of about 7 feet.

The fiber optic bundle can have a first end attached to a connector and a second end branching into a plurality of fiber optic strands having terminal ends terminating into and forming the pre-selected fixed pattern. The connector provides a means for transferring energy or signals from one source through the fiber optic bundle. The connector may be attached directly or indirectly to a transmitting light source transforming an energy source such as an electrical current into a light source.

The transmitting light source preferably is capable of producing a light in the visible spectrum which is transmitted through the fiber optic strand and emitted from the terminal end so as to be visible to the naked eye. The transmitting light source can be, for example, an illuminator or one or more light emitting diodes (LED) or a laser light. It is desirable to provide a variety of light colors through the fiber bundle. A variety of colors can be produced by breaking the spectrum of white light, filtering white light, or generating photon packages of discrete energy levels, using a color wheel in an illuminator, providing a plurality of LED emitting different colors, so as to produce visible light of varying colors emitted through the fiber bundles and traveling through the terminal ends of the fiber strands. The transmitter can also include signal conditioning electronics. The transmitting light source can modulate the light on or off or varied in intensity or vary the color and speed of color change. Optionally, the transmitter may be connected or include a combination with an optical modulator for varying the amplitude and phase of the light. The transmitter may optionally contain a fiber optic filter to allow transmission of only certain wavelengths while rejecting the transmission of other wavelengths, thereby providing desired color.

Fiber optic illuminators include those capable of accommodating various types and sizes of fibers and fiber bundles and connectors, having color wheels and sparkle wheels, with color synchronization. The illuminator may be equipped with a quartz halogen light, incandescent lamp, or any other suitable lamp, and optionally with a slide potentiometer. The color wheels can be provided with a variety of colors, such as 2 to 12 colors which can continuously change in a pre-arranged sequence or stay fixed in one color position. The color wheel can rotate at any desired or preset speed, such 0.5 seconds per color to several minutes (1-30) per color. Examples of colors include green, light red, dark red, light blue, medium blue, cobalt blue, white, yellow, purple, magenta, aqua, orange, or any other desired color. The illuminator desirably accommodates any number of fibers, and may, if desired, be fitted with a 50 to 3000 end-emitting fiber ferrule. Desirably, the wattage rating of the illuminator is low so as to be driven from an automotive battery. The illuminator is desirably powered by a DC power source.

LED light sources are preferably high brightness LEDs, optionally equipped with a collimating lens to capture and focus the LED light. There may be provided a plurality of LEDs, each emitting a different color light as described above. The LEDs may be simple or controllable. A single color LED light source may include round LEDs on a board, optionally with a housing. The colors, brightness, and lighting effects of the combination of LEDs are preferably controllable by an operator. LEDs have an advantage in that they can be powered by a low voltage and low wattage power source. The LED light source may be edge emitting or surface emitting. Edge emitting LED can produce a focused light beam around 20 to 60 μm in diameter, which provides good coupling with fiber optics. To provide a more powerful and focused signal, an edge emitting LED is preferred. Edge

Laser diodes are desirable if more power to the optical fiber is desired.

The connectors are preferably environmentally sealed accommodating single mode or multi mode fibers. The connectors may be both male and female, thereby allowing for extensions by mating the male and female ends. The interface should be moisture and dust free to provide optimal light transmission. The connectors are preferably self latching and have a quick connect and disconnect design. Common types of connectors that can be used include Biconic, SMA, SC, D4, ESCON, FC, FDDI, LC, Loopback, MTP, MT-RJ, MU, and FDDI.

In another embodiment, there is provided an energy source providing an electric current, such as a battery, connected directly or indirectly to a transmitting light source such as an illuminator or one or more LEDs. In the case of an illuminator, a ferrule accommodating a fiber optic bundle is fitted into the illuminator's optical port. The ferrule accommodates a fiber optic bundle harness fused into the ferrule. The fiber optic bundle is divided into a plurality of fiber optic cables each containing a plurality of fiber optic strands, or is directed in a sleeve or as a cable proximal to the indicia and divided into individual fiber optic strands fixed and secured into the indicia. The illuminator may be designed to accommodate several ferrules into one or more than one optical port.

The fiber optic strands can be divided into a plurality of groups, with each group corresponding to a light color or each group corresponding to a particular location or zone on the indicia.

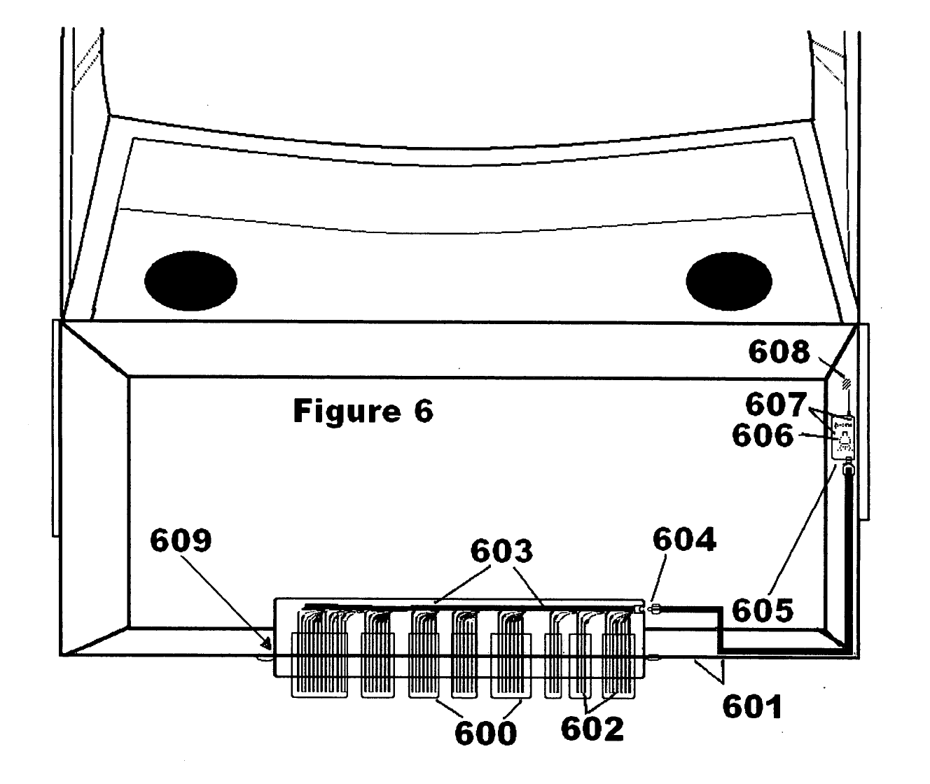

In another embodiment, as illustrated in FIG. 6, there is provided an indicia 600 mounted on or in a vehicle surface 601, preferably an outer surface, more preferably an outer surface of metal or plastic. The indicia may be mounted or sealed in a quick connect assembly base 609 so that the user or consumer has the option of merely mounting the whole assembly on or within the vehicle. The indicia 600 is visible to a viewer standing outside the vehicle, the indicia comprising a plurality of terminal fiber ends 602 fixed in place and having a pre-selected pattern which when illuminated, is discernable to the viewer as having the intended pre-selected pattern, said terminal fiber ends 602 converging into one or more bundle trunks 603. As depicted in the illustration, each bundle trunk converges into a receptacle into which a connector 604 can attach to connect to a transmitting light source housing 605 containing a light source 606 such as an incandescent bulb, halogen lamp, LED, or laser light effective to transmit light from the light source 606 into the core of one or more fibers within the trunk bundle 603. Preferably, the inner surfaces 607 of the transmitting light source housing are reflective so as to transmit light, which leaks from the direct feed of light, into the fiber core. The transmitting light source 606 is powered by an electric current generated from a suitable power source 608 located anywhere in the vehicle. The vehicle battery may be used, or in the case of LED's, an independent lower voltage rechargeable battery may be used. The transmitting light source may be equipped with an optical modulator, a color wheel, a dimmer, or programmed to activate the light source with certain events, such as braking, analog or digital sound signals, or a preselected intensity or color sequence that varies with time.

Although all the fibers connect into one receptacle as illustrated in FIG. 6, variations are possible. The fibers may converge into discrete bundle trunks each having their own receptacle on the quick connect assembly base into which several connectors are attached to connect to discrete light sources so that discrete and different light colors can illuminate each of the letters or different patterns on the indicia simultaneously or in a programmed order. One or more light sources may be provided, within one or more light source housings. For example, multiple LED light sources may be located within one light transmission housing containing compartments or channels or dedicated to each color LED, the main housing containing multiple ports for accepting a fiber optic bundle to transmit the light to the indicia. Alternatively, more than one LED light source may be provided within a transmitting light source housing, optionally within one compartment, connected to only one fiber optic bundle, with the different colors of the LED lights transmitting in a programmed sequence through one fiber optic bundle or through multiple fiber optic bundles. If desired, the light source may be contained within the quick connect assembly base such that the whole unit is self contained, requiring only a connection to a power source.

There is also provided a method for mounting an indicia on a motorized vehicle. An indicia package can be mounted on, through, or within a vehicle (the sole word “on”, “within,” “in,” or “through,” includes the all other variations throughout the specification unless otherwise stated). The indicia package comprises at least:

a) end emitting fiber optic strands having terminal ends fixed into a pre-selected pattern, or

b) end emitting fiber optic strands having terminal ends fixed into a pre-selected pattern connected directly or indirectly to a transmitting light source. In the method, the indicia package is connected to a transmitting light source; and a battery is directly or indirectly connected to the transmitting light source.

Other variations within the scope of the claims are included.

What we claim is:

1. An illuminable indicia for mounting onto a motorized vehicle comprising a fiber optic pattern assembly, said assembly comprising a fiber optic light bundle comprising a plurality of end emitting fiber optic strands terminating into terminal ends forming a pre-selected and fixed pattern corresponding to the shape of the indicia.

2. The indicia of claim 1, wherein said terminal ends terminate in multiple parallel planes.

3. The indicia of claim 1, wherein said terminal ends are molded into a thermoplastic or thermosetting resin.

4. The indicia of claim 3, wherein the resin is molded into the shape of the indicia.

5. The indicia of claim 3, wherein a portion of the fiber optic bundle is not molded into said resin.

6. The indicia of claim 1, wherein the plurality of fiber optic strands form multiple distinct patterns in which at least one pattern is capable of illuminating without illuminating one or more other patterns.

7. The indicia of claim 1, wherein the pattern is one or more letters.

8. The indicia of claim 1, wherein the pattern is one or more emblems.

9. The indicia of claim 1, wherein the pattern is one or more automotive logos.

10. The indicia of claim 1, wherein the terminal ends terminate within a plane and the pattern is contained within said plane.

11. The indicia of claim 1, wherein said fiber optic bundle comprises fiber optic strands, and at least one of said fiber optic strands split into two or more fiber optic strands.

12. The indicia of claim 1, wherein said fiber optic light bundle has a first end attached to a connector and a second end branching into a plurality of fiber optic strands having terminal ends terminating into and forming said pre-selected fixed pattern.

13. The indicia of claim 12, wherein said connector is attached directly or indirectly to a transmitter light source.

14. The indicia of claim 13, wherein the transmitter light source comprises a visible light illuminator.

15. The indicia of claim 14, wherein the illuminator contains a color wheel.

16. The indicia of claim 14, wherein the illuminator is programmed to emit a sequence of colored light through one or more fiber optic strands.

17. The indicia of claim 13, wherein the transmitter light source comprises a light emitting diode.

18. The indicia of claim 17, wherein one or more of said fibers are multi-mode fibers.

19. The indicia of claim 17, wherein the transmitting light source comprises 3 or more light emitting diodes.

20. The indicia of claim 19, wherein the light emitting diode is connected directly or indirectly to a battery.

21. The indicia of claim 20, wherein said battery comprises an automobile or motorcycle battery.

22. The indicia of claim 20, wherein said battery comprises a rechargeable batter rated at 9 V or less.

23. The indicia of claim 13, wherein the transmitting light source comprises a laser light.

24. The indicia of claim 13, wherein the transmitting light source changes the color of light emitted from at least a portion of the terminal ends of the fiber optic pattern.

25. The indicia of claim 1, comprising a package comprising said fiber optic assembly, a transmitting light source, and a connector on the transmitting light source suitable for directly or indirectly connecting the transmitting light source to said fiber optic assembly.

26. The indicia of claim 1, wherein the pattern is mounted into the body of a motorized vehicle.

27. The indicia of claim 1, wherein the pattern is mounted into the instrument panel of a motorized vehicle.

28. The indicia of claim 1, wherein the pattern is mounted into the seat of a motorized vehicle.

29. The indicia of claim 1, wherein the pattern forms pin striping on a headliner or interior door panels.

30. A method for mounting an indicia on a motorized vehicle, comprising mounting an indicia package on the vehicle, said indicia package comprising:
a) end emitting fiber optic strands having terminal ends fixed into a pre-selected pattern, or
b) end emitting fiber optic strands having terminal ends fixed into a pre-selected pattern connected directly or indirectly to a transmitting light source, and if the indicia package comprises a), connecting the indicia package a) to a transmitting light source; and connecting a battery directly or indirectly to the transmitting light source.
